(19) United States
(12) Patent Application Publication
(10) Pub. No.: US 2002/0077830 A1
(43) Pub. Date: Jun. 20, 2002

(54) Method for activating context sensitive speech recognition in a terminal

(75) Inventors: Riku Suomela, Tampere (FI); Juha Lehikoinen, Tampere (FI)

Correspondence Address: Michael C. Stuart, Esq., Cohen, Pontani, Lieberman & Pavane, Suite 1210, 551 Fifth Avenue, New York, NY, 10176, US

(73) Assignee: Nokia Corporation

(21) Appl. No.: 09/740,277

(22) Filed: Dec. 19, 2000

(51) Int. Cl. G10L 11/00; G10L 21/00

(52) U.S. Cl. 704/275

(57) ABSTRACT

A process for activating speech recognition in a terminal includes automatically activating speech recognition when the terminal is used and turning the speech recognition off after a time period has elapsed after activation. The process also takes the context of the terminal into account when the terminal is activated and defines a subset of allowable voice commands which correspond to the current context of the device.

### BACKGROUND OF THE INVENTION

1. Field of the Invention

The present invention relates to a method and device for activating speech recognition in a user terminal.

2. Description of the Related Art

The use of speech as an input to a terminal of an electronic device such as a mobile phone frees a user's hands and also allows a user to look away from the electronic device while operating the device. For this reason, speech recognition is increasingly being used in electronic devices instead of conventional inputs such as buttons and keys so that a user can operate the electronic device while performing other tasks such as walking or driving a motor vehicle. Speech recognition, however, requires high consumption of the terminal's power and processing time because the electronic device must continuously monitor audible signals for recognizable commands. These problems are especially acute for mobile phones and wearable computers where power and processing capabilities are limited.

In some prior art devices, speech recognition is active all times. While this solution is useful for some applications, it requires a large power supply and processing capabilities. Therefore, this solution is not practical for a wireless terminal or a mobile phone.

Other prior art devices activate speech recognition via a dedicated speech activation command. In these prior art devices, a user must first activate speech recognition and then activate the first desired command via speech. This solution takes away from the advantages of speech recognition in that it adds an additional step. The user must first activate the speech recognition and then start activating the required functions. Accordingly, a user must divert his attention to the device momentarily to perform the additional step of activating the speech recognition before the first command is activated.

### SUMMARY OF THE INVENTION

To overcome limitations in the prior art described above, and to overcome other limitations that will become apparent upon reading and understanding the present specification, it is an object of the present invention to provide a method and device for activating speech recognition in a terminal that exhibits low resource demands and does not require a separate activation step.

The object of the present invention is met by a method for activating speech recognition in a terminal in which the terminal detects an event, performs a first command in response to the event, and automatically activates speech recognition at the terminal in response to the detection of the event for a speech recognition time period. The terminal further determines whether a second command is received during the speech recognition time period. The second command may be a voiced command received via speech recognition or a command input via the primary input. After the speech recognition time period has elapsed, speech recognition is deactivated. After deactivation, the second command must be received via the primary input.

The object of the present invention is also met by a terminal capable of speech recognition having a central processing unit connected to a memory unit, a primary input for recording inputted commands, a secondary input for recording audible commands, and a speech recognition algorithm for executing speech recognition. A primary control circuit is also connected to the central processing unit for processing the inputted commands. The primary control circuit activates speech recognition in response to an event for a speech recognition time period and deactivates speech recognition after the speech recognition time period has elapsed.

The terminal according to the present invention may further include a word set database and a secondary control circuit connected to the central processing unit. The secondary control circuit determines a context in which the speech recognition is activated and determines a word set of applicable commands in the context from the word set database.

The event for activating the speech recognition may include use of the primary input, receipt of information at the terminal from the environment, and notification of an external event such as a phone call.

According to the present invention, speech recognition is automatically activated in a device, i.e., terminal, when the device is used and the speech recognition is turned off when it is not needed. Since the speech recognition feature is not always on, the resources of the device are not constantly being used.

The method and device according to the present invention also takes the context into account when defining a set of allowable inputs, i.e., voice commands. Accordingly, only a subset of a full speech dictionary or word set database of the device is used at one time. This makes possible quicker and more accurate speech recognition. For example, a mobile phone user typically must press a “menu” button to display a list of available options. According to the present invention, the depression of the “menu” button indicates that the phone is being used and automatically activates speech recognition. The device (phone) then determines the available options, i.e., the context, and listens for words specific to the available options. After a time limit has expired with no recognizable commands, the speech recognition is automatically deactivated. After the speech recognition is deactivated, the user may input a command via the keyboard or other primary input. Furthermore, since only a small set of words are used within each context, a greater overall set of words is possible using the inventive method.

It is difficult for a user to remember all words recognizable via speech recognition. Accordingly, the method according to the present invention displays the subset of words which are recognizable in the current context. If the current context is a menu, the available commands are the menu items which are typically displayed anyway. The subset of recognizable commands may be audibly given to a user via a speaker instead of or in addition to displaying the available commands.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements:

FIG. 1 is a block diagram of a terminal according to an embodiment of the present invention;

FIG. 2 is a flow diagram of a process for activating speech recognition according to another embodiment of the present invention;

FIG. 2A is a flow diagram of a further embodiment of the process in FIG. 2;

FIG. 2B is a flow diagram of yet another embodiment of the process in FIG. 2; and

FIG. 3 is a state diagram according to the process embodiment of the present invention of FIG. 2.

### DETAILED DESCRIPTION OF THE PRESENTLY PREFERRED EMBODIMENTS

In the following description of the various embodiments, reference is made to the accompanying drawings which form a part hereof, and in which is shown by way of illustration various embodiments in which the invention may be practiced. It is to be understood that other embodiments may be utilized, and structural and functional modifications may be made without departing from the scope of the present invention.

The present invention provides a method for activating speech recognition in a user terminal which may be implemented in any type of terminal having a primary input such as a keyboard, a mouse, a joystick, or any device which responds to a gesture of the user such as a glove for a virtual reality machine. The terminal may be a mobile phone, a personal digital assistant (PDA), wireless terminal, a wireless application protocol (WAP) based device or any type of computer including desktop, laptop, or notebook computers. The terminal may also be a wearable computer having a head-mounted display which allows the user to see a virtual data while simultaneously viewing the real world. To conserve power and processor use, the present invention concludes when to activate speech recognition based on actions performed on the primary input and deactivates the speech recognition after a time period has elapsed after the activation. The present invention further determines the context within which the speech recognition is activated. That is, the present invention determines an available command set as a subset of a complete word set that is available in a given use context each time the speech recognition is activated. The inventive method is especially useful when the terminal is a mobile phone or a wearable computer where power consumption is a key issue and input device capabilities are limited.

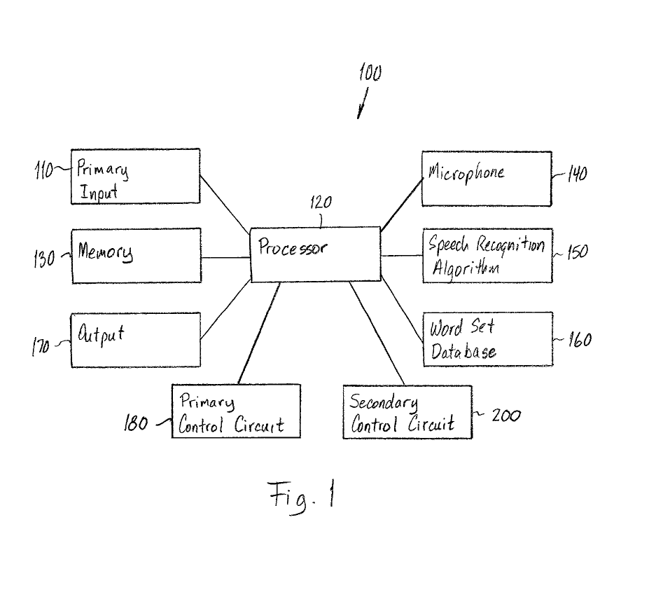

FIG. 1 is a block diagram of a terminal 100 in which the method according to an embodiment of the present invention may be implemented. The terminal has a primary input device 110 which may comprise a QWERTY keyboard, buttons on a mobile phone, a mouse, a joystick, a device for monitoring hand movements such as a glove used in a virtual reality machine for sensing movements of a users hands, or any other device which senses gestures of a user for specific applications. The terminal also has a processor 120 such as a central processing unit (CPU) or a micro-processor and a random-access-memory (RAM) 130. A secondary input 140 such as a microphone is connected to the processor 120 for receiving audible or voice commands. For speech recognition functionality, the terminal 100 comprises a speech recognition algorithm 150 which may be saved in the RAM 130 or may be saved as a read-only-memory (ROM) in the terminal. Furthermore, a word set database 160 is also arranged in the terminal 100. The word set database is searchable by the processor 120 under the speech recognition algorithm 150 to recognize a voice command. The word set database 160 may also be arranged in the RAM 130 or as a separate ROM. If the word set database 160 is saved in the RAM 130, it may be updated to include new options or delete options that are no longer applicable. An output device 170 may also be connected to or be a part of the terminal 100 and may comprise a display and/or a speaker. In the preferred embodiment, the terminal comprises a mobile phone, and all of the parts are integrated in the mobile phone. However, the terminal may comprise any electronic device and some of the above components may be external components. For example, the memory 130, comprising the speech recognition algorithm 150 and word set database, may be connected to the device as a plug-in.

A primary control circuit 180 is connected to the processor 120 for processing commands received at the terminal 100. The primary control circuit 180 also activates the speech recognition algorithm in response to an event for a predetermined time and deactivates the speech recognition after the predetermined speech recognition time has elapsed. A secondary control circuit 200 is connected to the processor 120 to determine the context in which the speech recognition is activated and to determine a subset of commands from the word set database 160 that are applicable in the current context. Although the primary control circuit 180 and the secondary control circuit 200 are shown as being external to the processor 120, they may also be configured as an integral part thereof.

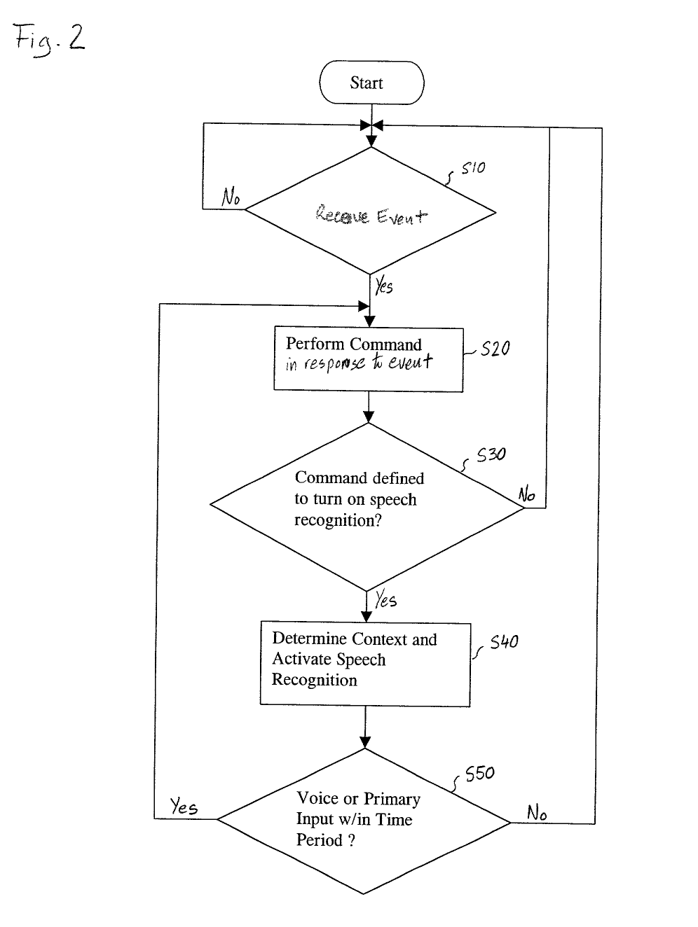

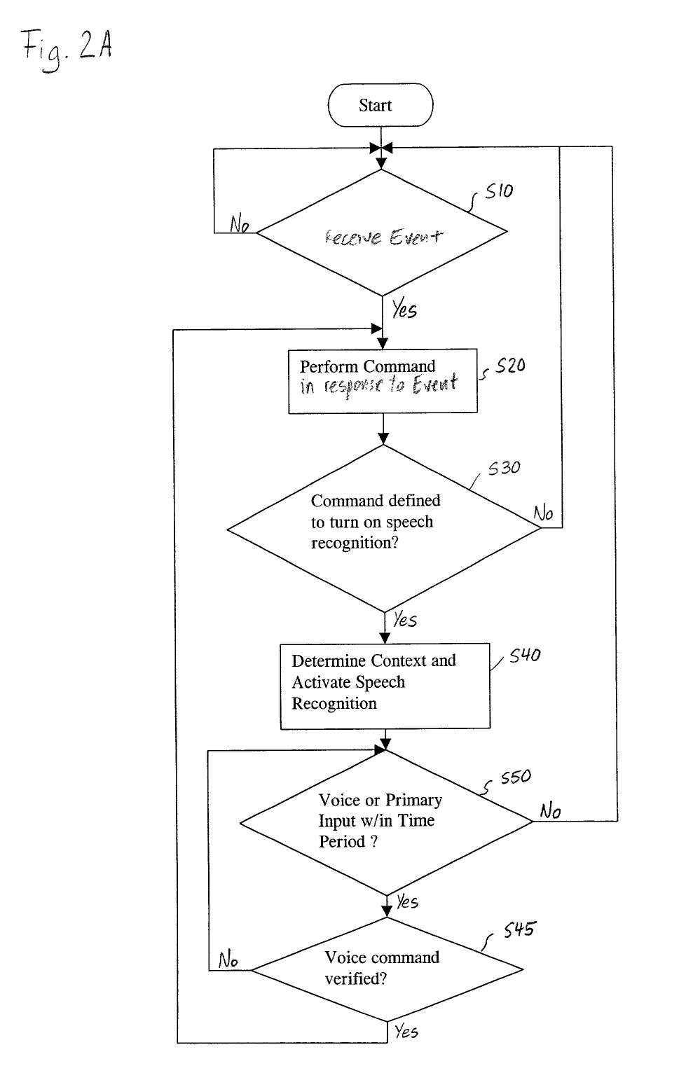

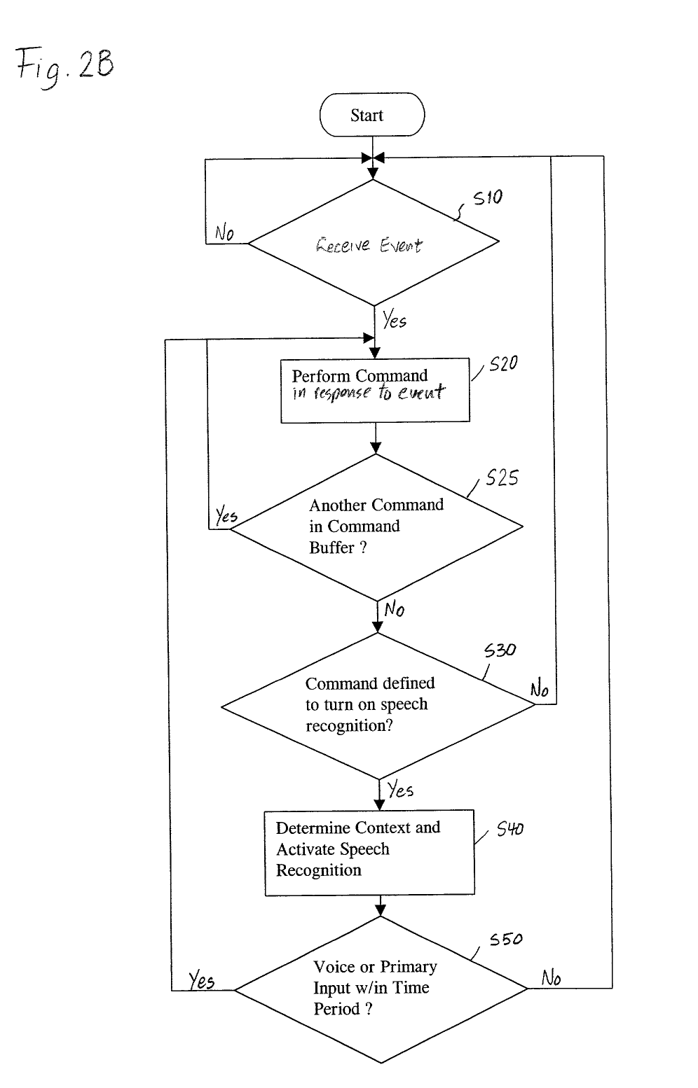

FIG. 2 is a flow diagram depicting the method according to an embodiment of the present invention which may be effected by a software program acting on the processor 120. At step S10, the terminal waits for an event at the terminal 100. The event may comprise the use of the primary input 110 by the user to input a command, a receipt at the terminal 100 of new information in the environment, and/or a notification of an external event such as, for example, a phone call or short message from a short message service (SMS). If the terminal 100 is a wearable computer, it may comprise a context-aware application that can determine where the user is and include information about the environment surrounding the user. Within this context-aware application, virtual objects are objects with a location and a collection of these objects creates a context. These objects can easily be accessed by pointing at them. When a user points to an object or selects an object (i.e., by looking at the object with a head worn display of the wearable computer), an open command appears at the button menu. The selection of the object activates the speech recognition and the user can say the command “open”. Speech activation may also be triggered by an external event. For example, the user may receive an external notification such as a phone call or short message which activates the speech recognition.

At step S20, the processor 120 performs a command in response to the event. The processor 120 then determines whether the command is one that activates speech recognition, step S30. If it is determined in step S30 that the command is not one that activates speech recognition, the terminal 100 then returns to step S10 and waits for an additional event to occur. If it is determined in step S30 that the command is one that activates speech recognition, the processor 120 determines the context or current state of the terminal 100, determines a word set applicable to the determined context from the word set database 160, and activates speech recognition, step S40. The applicable word set may comprise a portion of the word set database 160 or the entire word set database 160. Furthermore, when the applicable word set comprises a portion of the word set database, there may be a subset of the word set database 160 that is applicable in all contexts. For example, if the terminal is a mobile phone, the subset of applicable commands in all contexts may include “answer”, “shut down”, “call”, “silent”.

If the terminal 100 is arranged so that all events activate speech recognition, step S30 may be omitted so that step S40 is always performed immediately after completion of step S20.

After the speech recognition is activated in step S40, the processor monitors the microphone 140 and the primary input 110 for the duration of a speech recognition time period, S50. The time period may have any desired length depending on the application. In the preferred embodiment the time period is at least 2 seconds. Each command received by the microphone 140 is searched for in the currently applicable word set. If a command is recognized, the process return to step S20 where processor 120 performs the command.

To ensure that the correct command is performed, step S45 may be performed as depicted in step FIG. 2A which verifies that the command recognized is the one that the user intends to perform. In step S45, the output 170 either displays the command that is recognized or audibly broadcasts the command that is recognized and gives the user a choice of agreeing with the choice by saying “yes” or disagreeing by saying “no”. If the user disagrees with the recognized command, step S50 is repeated. If the user agrees, step S20 is performed for the command.

If the speech recognition time period expires before a voiced command is recognized or a command is input via the primary input in step S50, then the only option is to input a command via the primary input in step S10. After an event is received in step S10 via the primary input 110, the desired action is performed in step S20. This process continues until the terminal is turned off.

Step S40 may also display the list of available commands at the output 170. Smaller devices such as mobile phones, PDAs, and other wireless devices may have screens which are too small to display the entire list of currently available commands. However, even those commands of the currently available commands which are not displayed are recognizable. Accordingly, if a user is familiar with the available commands, the user can say the command without having to scroll down the menu until it appears on the display, thereby saving time and avoiding handling the device. The output 170 may also comprise a speaker for audibly listing the currently available commands in addition or as on alternative to the display.

In a further embodiment shown in FIG. 2B, more than one voice command may be received at step S50 and saved in a buffer in the memory 130. In this embodiment, the first command is performed at step S20. After step S20, the device determines whether there is a further command in the command buffer, step S25. If it is determined that another command exists, step S20 is performed again for the second command. The number of commands which may be input at once is limited by the size of the buffer and how many commands are input before the speech recognition time period elapses. After it is determined in step S25 that the last command in the command buffer has been performed, the terminal 100 then performs step S30 as in FIG. 2 for the last command performed in step S20. As in the previous Figures, the process continues until the device is turned off.

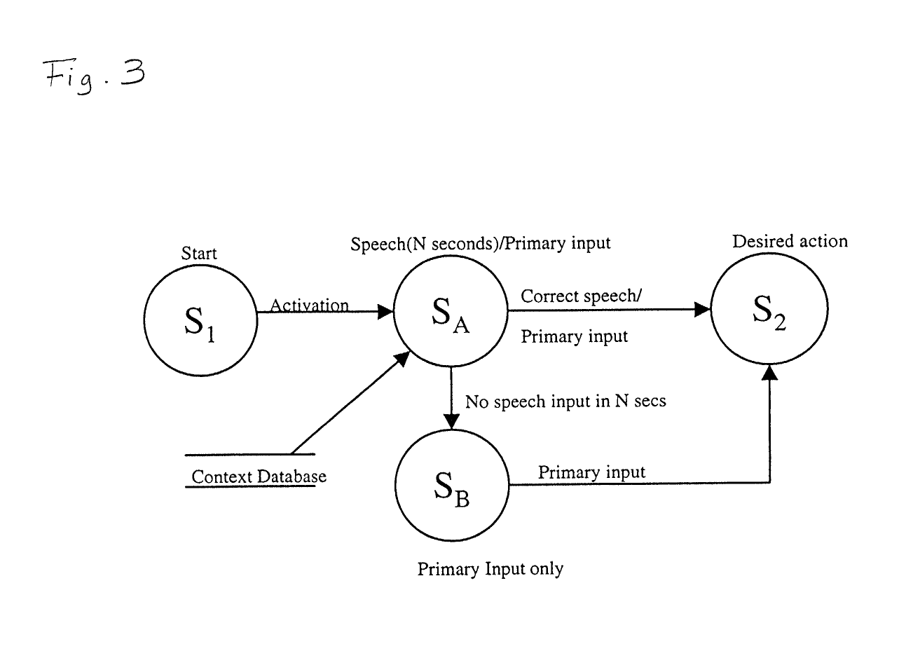

FIG. 3 shows a state diagram of the method according to an embodiment of the present invention. In FIG. 3, the state S₁ is the state of the terminal 100 before an event is received at the terminal. After activation of speech recognition, the terminal 100 is in state S_{A} in which it monitors both the microphone 140 and the primary input 110 for commands. If a recognizable command is input via the microphone or the primary input 110, the terminal is put into state S₂ where the desired action is performed. If no recognizable command is input after the speech recognition time period has elapsed, speech recognition is deactivated and the terminal is put into state S_{B} where the only option is to input a command with the primary input 110. When a command is input via the primary input 110 in state S_{B,} the terminal is put into state S₂ and the desired action is performed.

In a first specific example which relates to the flow diagram of FIG. 2, the terminal 100 comprises a mobile phone and the primary input 110 comprises the numeric keypad and other buttons on the mobile phone. If a user wants to call a friend named David, the user presses the button of the primary input 110 that activates name search, step S10. The phone then lists the names of records stored in the mobile phone, i.e., performs the command, step S2O. In this embodiment, it is assumed that all actions activate the speech recognition and therefore, step S30 is skipped. Next, the context is determined, the applicable subset of commands is chosen, and the speech recognition is activated, step S40. In this case, the applicable subset of commands contains the names saved in the user's phone directory in the memory 130 of the terminal 100. Next, the user can browse the list in the conventional way, i.e., using the primary input 110, or the user can say “David” while the speech recognition is activated. After recognition of the command “David” in step S50, the record for David is automatically selected, step S2O. Now step S40 is performed in response to the command “David” and a new set of choices is available, i.e., “call”, “edit”, “delete”. That is, context of use is changed. The selection of David acts as another action which reactivates the speech recognition. Again, the user can select in the conventional way via the buttons on the mobile phone or can say “call”, step S50. The phone may verify, step S45 (FIG. 2A), by asking on a display or audibly, “Did you say call?”. The user can confirm by replying “yes”. The call is now made.

In a second example which relates to the flow diagram of FIG. 2B, a user is browsing a calendar for appointments on a PDA. The user starts the calendar application, step S10, and the calendar application is brought up on the display, step S20. At step S50 a user says “show tomorrow”. This actually is two commands, “show” and “tomorrow”, which are saved in the command buffer and handled one at a time. “Show” activates the next context at step S20 and step S25 determines that another command is in the command buffer. Accordingly, step S20 is performed for the “tomorrow” command. After “tomorrow” is handled, the device 100 determines that there are no further commands in the buffer and the PDA shows the calendar page for tomorrow and starts the speech recognition at step S40. The user can now use the primary input or voice to activate further commands. The user may state a combination “add meeting twelve”, which has three commands to be interpreted. The process ends at a state where the user can input information about the meeting via the primary input. At this context, speech recognition may not be applicable for entering information about the meeting. Accordingly, at step S30, the terminal 100 would determine that the last command does not activate speech recognition and return the process to step S10 to receive only the primary input.

In yet another example, the terminal 100 is a wearable computer with a context-aware application. In this example, contextual data includes a collection of virtual objects corresponding to real objects within a limited area surrounding the user's actual location. For each virtual object, the database includes a record comprising at least a name of the object, a geographic location of the object in the real world, and information concerning the object. The user may select an object when the object is positioned in front of the user, i.e., when the object is pointed to by the user. In this embodiment, the environment may activate the speech recognition as an object becomes selected, step S10. Once the object becomes selected, the “open” command becomes available, step S20. The terminal recognizes that this event turns on speech recognition and speech recognition is activated, steps S30 and S40. Accordingly, the user can then voice the “open” command to retrieve further information about the object, step S50. Once the information is displayed, other commands may then be available to the user such as “more” or “close”, step S20.

In a further example, the terminal 100 enters a physical area such as a store or a shopping mall and the terminal 100 connects to a local access point or a local area network, e.g., via Bluetooth. In this embodiment, the environment outside the terminal activates speech recognition when the local area network establishes a connection with the terminal 100, step S10. Once the connection is established, commands related to the store environment become available to the user such as, for example, “info”, “help”, “buy”, and “offers”. Accordingly, the user can voice the command “offers” at step S50 and the terminal 100 queries the store database via the Bluetooth connection for special offers, i.e., sales and/or promotions. These offers may then be displayed on the terminal output 170 which may comprise a terminal display screen if the terminal 100 is a mobile phone or PDA or virtual reality glasses if the terminal 100 is a wearable computer.

The environment does not have to be the surroundings of the terminal 100 and may also include the computer environment. For example, a user may be using the terminal 100 to surf the Internet and browse to a site www.grocerystore.com. The connection to this site may comprise an event which activates speech recognition. Upon the activation of speech recognition, the processor may query the site to determine applicable commands. If these commands are recognizable by the speech recognition algorithm, i.e., contained in the word set database 160, the commands may be voiced. If a portion of the applicable commands are in the word set database 160, the list of commands may be displayed so that those commands which may be voiced are highlighted to indicate to the user which commands may be voced and which commands must be input via the primary input device. The user can select items that the user wishes to purchase by providing voice commands or by selecting products via the primary input 110 as appropriate. When the user is finished shopping, the user is presented with the following commands “yes”, “no”, “out”, “back”. The “yes” and “no” commands may be used to confirm or refuse the purchase of the selected items. The “out” command may be used to exit the virtual store, i.e., the site www.grocerystore.com. The “back” commands may be used to go back to a previous screen.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for activating speech recognition in a terminal, comprising the steps of:
(a) detecting an event at the terminal;
(b) performing a first command in response to the event of step (a);
(c) automatically activating speech recognition at the terminal in response to said step (a);
(d) determining whether a second command is received via one of speech recognition and the primary input during a speech recognition time period commenced upon a completion of said step (b);
(e) deactivating speech recognition at the terminal and determining whether the second command is received via the primary input if it is determined that the second command is not received in said step (d) during the speech recognition time period; and
(f) performing the second command received in one of said steps (d) and (e).

2. The method of claim 1, wherein said step (a) comprises detecting one of a use of a primary input of the terminal, receipt of information at the terminal from the environment of the terminal, and notification of an external event.

3. The method of claim 1, wherein said step (c) further comprises determining a context in which speech recognition is activated and determining a word set of applicable commands in that context.

4. The method of claim 3, wherein the word set determined in said step (c) comprises a default word set comprising commands that are applicable in all contexts.

5. The method of claim 3, wherein said step (c) further comprises displaying at least a portion of the applicable commands of the word set.

6. The method of claim 3, wherein said step (c) further comprises audibly outputting the applicable commands of the word set.

7. The method of claim 1, wherein said step (f) further comprises verifying that the second command received via speech recognition is correct.

8. The method of claim 1, wherein said step (c) further comprises displaying at least a portion of the applicable commands of the word set.

9. The method of claim 1, wherein said step (c) further comprises audibly outputting the applicable commands of the word set.

10. The method of claim 1, wherein said step (d) further comprises receiving at least one second command via speech recognition during the speech recognition time period and saving said at least one second command in a command buffer.

11. The method of claim 10, wherein said step (f) comprises performing each command of said at least one second command in said command buffer.

12. The method of claim 11, further comprising the step of (g) repeating said steps (c)-(f) in response to the command last performed in said step (f).

13. The method of claim 1, further comprising the step of repeating said steps (c)-(f) for the command last performed in said step (f).

14. The method of claim 11, further comprising the step of repeating said steps (c)-(f) in response to the last command performed by said step (f) if it is determined that the last command performed in said step (f) is an input defined to activate speech recognition.

15. The method of claim 1, further comprising the step of determining whether the first command input in said step (a) is a command defined to activate speech recognition and wherein said steps (b)-(d) are performed only if it is determined that the first command performed in said step (a) is an action defined to activate speech recognition.

16. The method of claim 1, wherein said step (a) comprises pressing a button.

17. The method of claim 1, wherein said step (a) comprises pressing a button on a mobile phone.

18. The method of claim 1, wherein said step (a) comprises pressing a button on a personal digital assistant.

19. The method of claim 1, wherein the terminal is a wearable computer with a context-aware application and said step (a) comprises receiving information from the environment of the wearable computer.

20. The method of claim 19, wherein the information is that an object in the environment has been selected.

21. The method of claim 20, wherein the second command is an open command for accessing information about the selected object.

22. The method of claim 1, wherein step (a) comprises receiving a notification from an external source.

23. The method of claim 22, wherein the notification is one of a phone call and a short message.

24. The method of claim 1, wherein said step (a) comprises connecting to one of a local access point and a local area network via short range radio technology.

25. The method of claim 1, wherein said step (a) comprises receiving information at the terminal from the computer environment of the terminal.

26. The method of claim 25, wherein said step (a) comprises connecting to a site on the internet.

27. A terminal capable of speech recognition, comprising:
a central processing unit;
a memory unit connected to said central processing unit;
a primary input connected to said central processing unit for receiving inputted commands;
a secondary input connected to said central processing unit for receiving audible commands;
a speech recognition algorithm connected to said central processing unit for executing speech recognition; and
a primary control circuit connected to said central processing unit for processing said inputted and audible commands and activating speech recognition in response to an event for a speech recognition time period and deactivating speech recognition after the speech recognition time period has elapsed.

28. The terminal of claim 27, wherein said event comprises one of a use of a primary input of the terminal, receipt of information from the environment of the terminal, and notification of an external event.

29. The terminal of claim 27, further comprising a word set database connected to said central processing unit and a secondary control circuit connected to said central processing unit for determining a context in which the speech recognition is activated and determining a word set of applicable commands in said context from said word set database.

30. The terminal of claim 29, further comprising a display for displaying at least a portion of said word set.

31. The terminal of claim 27, wherein said primary input comprises buttons.

32. The terminal of claim 31, wherein said terminal comprises a mobile phone.

33. The terminal of claim 31, wherein said terminal comprises a personal digital assistant.

34. The terminal of claim 27, wherein said terminal comprises a wearable computer.

35. The terminal of claim 34, wherein said means for activating speech recognition comprises means for activating speech recognition in response to a selection of an object in an environment of said wearable computer.

36. The terminal of claim 27, wherein said means for activating speech recognition comprises means for activating speech recognition in response to receiving notification of one of a phone call and a short message at said terminal.

37. The method of claim 27, wherein said means for activating speech recognition comprises means for activating speech recognition in response to connecting said terminal to one of a local access point and a local area network via short range radio technology.

38. The method of claim 27, wherein said means for activating speech recognition comprises means for activating speech recognition in response to receiving information at said terminal from a computer environment of said terminal.

39. The method of claim 38, wherein said means for activating speech recognition comprises means for activating speech recognition in response to connecting said terminal to a site on the internet.

40. A system for activating speech recognition in a terminal, comprising:
a central processing unit;
a memory unit connected to said processing unit;
a primary input connected to said central processing unit for receiving inputted commands;
a secondary input connected to said central processing unit for receiving audible commands;
a speech recognition algorithm connected to said central processing unit for executing speech recognition; and
software means operative on the processor for maintaining in said memory unit a database identifying at least one context related word set, scanning for an event at the terminal, performing a first command in response to the event, activating speech recognition by executing said speech recognition algorithm for a speech recognition time period in response to detecting said event at said terminal, deactivating speech recognition after the speech recognition time period has elapsed, and performing a second command received during said speech recognition time.

41. The system of claim 40, wherein said event comprises one of a use of a primary input of the terminal, receipt of information from the environment of the terminal, and notification of an external event.

42. The terminal of claim 40, wherein said means for activating speech recognition comprises means for activating speech recognition in response to a selection of an object in an environment of said wearable computer.

43. The terminal of claim 40, wherein said means for activating speech recognition comprises means for activating speech recognition in response to receiving notification of one of a phone call and a short message at said terminal.

44. The method of claim 40, wherein said means for activating speech recognition comprises means for activating speech recognition in response to connecting said terminal to one of a local access point and a local area network via short range radio technology.

45. The method of claim 40, wherein said means for activating speech recognition comprises means for activating speech recognition in response to receiving information at said terminal from a computer environment of said terminal.

46. The method of claim 45, wherein said means for activating speech recognition comprises means for activating speech recognition in response to connecting said terminal to a site on the internet.
